(19) United States
(12) Patent Application Publication
(10) Pub. No.: US 2013/0210422 A1
(43) Pub. Date: Aug. 15, 2013

(54) SYSTEMS AND/OR METHODS FOR PROVIDING MOBILITY ROBUSTNESS IN HETEROGENEOUS NETWORK AND SMALL CELL DEPLOYMENTS

(71) Applicants: Diana Pani, Montreal (CA); Paul Marinier, Brossard (CA)

(72) Inventors: Diana Pani, Montreal (CA); Paul Marinier, Brossard (CA)

(73) Assignee: INTERDIGITAL PATENT HOLDINGS, INC., Wilmington, DE (US)

(21) Appl. No.: 13/571,845

(22) Filed: Aug. 10, 2012

Related U.S. Application Data
(60) Provisional application No. 61/522,720, filed on Aug. 12, 2011.

(51) Int. Cl. H04W 8/02

(52) U.S. Cl. CPC H04W 8/02
USPC 455/423

(57) ABSTRACT

Systems and methods for providing mobility robustness in a heterogeneous network may be provided. For example, information such as a physical cell identity (PCI) may be received from a network and/or an occurrence of an event or trigger may be detected. Based on the information or the occurrence of the event or trigger, a determination may be made as to whether a robustness situation may be configured to occur and/or whether to initiate a mobility robustness action. When a robustness situation may be configured to occur and/or a mobility robustness action may be configured to be initiated, the mobility robustness action may then be performed.

### CROSS-REFERENCE TO RELATED APPLICATIONS

This application claims the benefit of U.S. Provisional Application No. 61/522,720, filed Aug. 12, 2011, the content of which is hereby incorporated by reference in its entirety.

### BACKGROUND

Today, to increase system capacity, a wireless operator may deploy heterogeneous networks that include cells of different sizes such as macro cells, pico cells, femto cells, and the like. However, current mobility mechanisms or procedures including parameters, handovers, triggers, re-establishment, and the like are designed for a homogenous network that includes cells of the same size such macro cells. For example, current handover procedures are designed to switch from one cell to another cell where each of the cells are the same size and, unfortunately, tend to lead to failures when switching from a larger cell to a smaller cell or a smaller cell to a larger cell. As such, current mobility mechanisms or procedures designed for homogenous networks are not well-suited for use in heterogeneous networks.

### SUMMARY

Systems and methods for providing mobility robustness in a heterogeneous network may be provided. For example, information such as a physical cell identity (PCI), configuration information, measurement information, and/or network information may be received (e.g. from a network) and/or an occurrence of an event or trigger such as a measurement event or trigger, a proximity mobility trigger or event, and the like may be detected. Based on the information or the occurrence of the event or trigger, a determination may be made as to whether a robustness situation may be configured to occur and/or whether to initiate a mobility robustness action. When a robustness situation may be configured to occur and/or a mobility robustness action may be configured to be initiated, the mobility robustness action may then be performed. The mobility robustness action may include a target cell pre-configuration procedure, a pre-handover preparation, an active time extension in discontinuous reception (DRX), application of an almost blank subframe (ABS), modification of a measurement configuration, modification of a mobility state, and the like. According to an example embodiment, a handover may be performed after or in response to the mobility robustness action and/or using information associated with or received in response to the mobility robustness action and/or received from the network.

The Summary is provided to introduce a selection of concepts in a simplified form that are further described below in the Detailed Description. This Summary is not intended to identify key features or essential features of the claimed subject matter, not is it intended to be used to limit the scope of the claimed subject matter. Furthermore, the claimed subject matter is not limited to any limitations that solve any or all disadvantages noted in any part of this disclosure.

### BRIEF DESCRIPTION OF THE DRAWINGS

A more detailed understanding of the embodiments disclosed herein may be had from the following description, given by way of example in conjunction with the accompanying drawings.

FIG. 1A depicts a diagram of an example communications system in which one or more disclosed embodiments may be implemented.

FIG. 1B depicts a system diagram of an example wireless transmit/receive unit (WTRU) that may be used within the communications system illustrated in FIG. 1A.

FIG. 1C depicts a system diagram of an example radio access network and an example core network that may be used within the communications system illustrated in FIG. 1A.

FIG. 1D depicts a system diagram of another example radio access network and an example core network that may be used within the communications system illustrated in FIG. 1A.

FIG. 1E depicts a system diagram of another example radio access network and an example core network that may be used within the communications system illustrated in FIG. 1A.

FIG. 2 depicts an example embodiment of a heterogeneous network.

FIG. 3 depicts an example embodiment of flow diagrams of an embodiment of mobility robustness method.

### DETAILED DESCRIPTION

Systems and/or methods for providing mobility robustness in a heterogeneous network comprising cells of different sizes (e.g. macro cells, pico cells, and the like) may be disclosed. Such systems and methods may detect, determine, and/or identify whether a mobility robustness situation may exist or may potentially exist in the network (e.g. based on one or more cells included therein) and may perform, apply, and/or invoke an action that may be configured to mitigate, reduce, and/or eliminate the mobility robustness situation. For example, a determination may be made regarding whether a network may have a deployment (e.g. cells of different sizes such as macro cells, pico cells, and the like) that may cause or potentially cause problems for current mobility procedures (e.g. a mobility robustness situation may exist or may potentially exist). When such a determination indicates such problems may exist or may potentially exist (e.g. the network may be in a particular deployment), procedures or actions disclosed herein (e.g. mobility robustness actions) may be performed, invoked, or applied. Such actions may include one or more of the following: a target cell pre-configuration (e.g. including obtaining a pre-configuration of the target cell, and UE behavior for executing a handover to the target cell), an extension of active time to improve reliability of the reception of a handover command, activation of almost blank subframe (ABS) pattern that may be obtained (e.g. in advance), modification to a measurement configuration to improve performance of measurement reporting, and the like. Additionally, one or more triggers (e.g. that may be used to detect, determine, and/or identify a mobility robustness situation) such as a proximity-based trigger, a measurement report mobility trigger, a measurement mobility trigger, and the like may also be provided (e.g. to enable or disable one or more of the above actions).

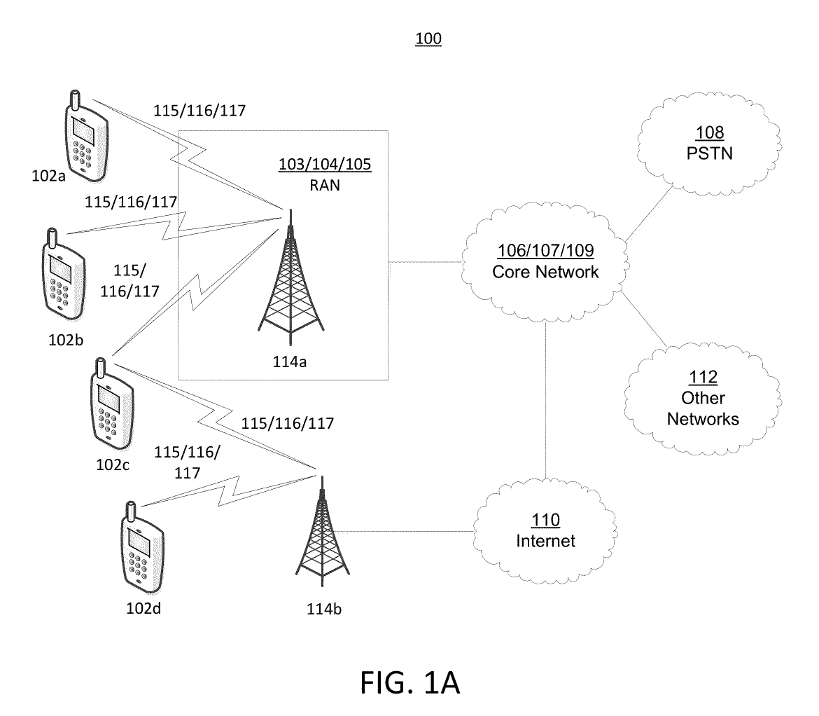

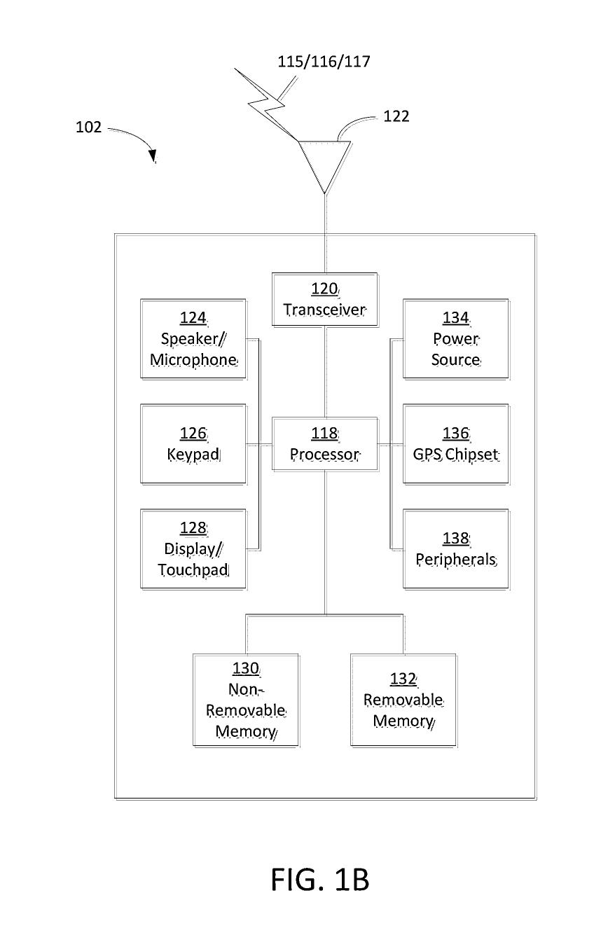

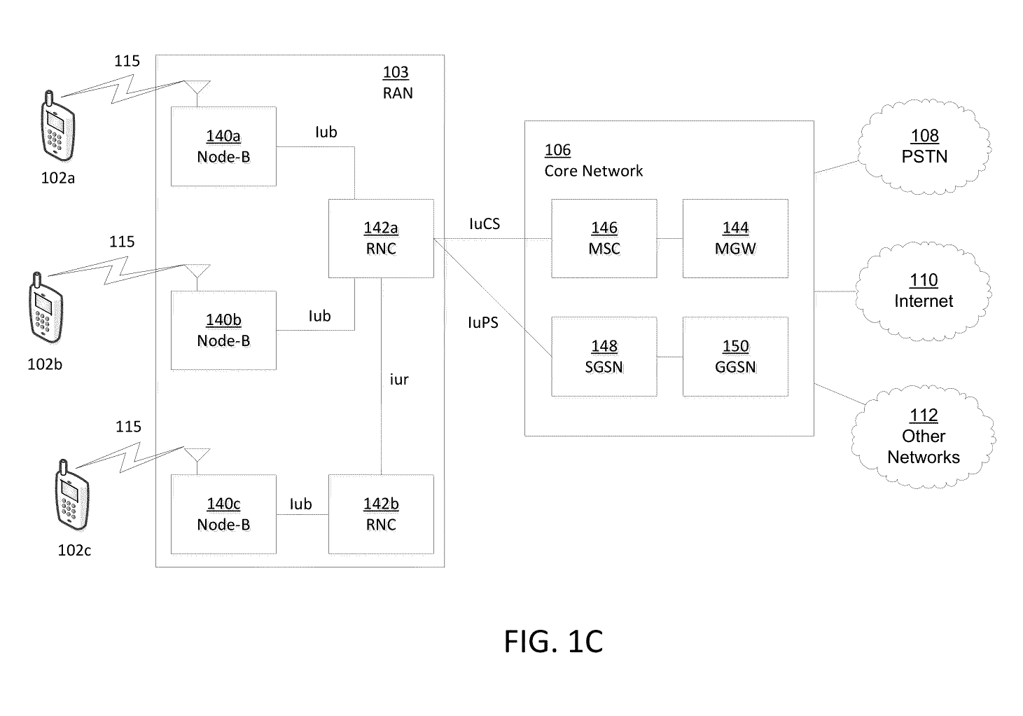

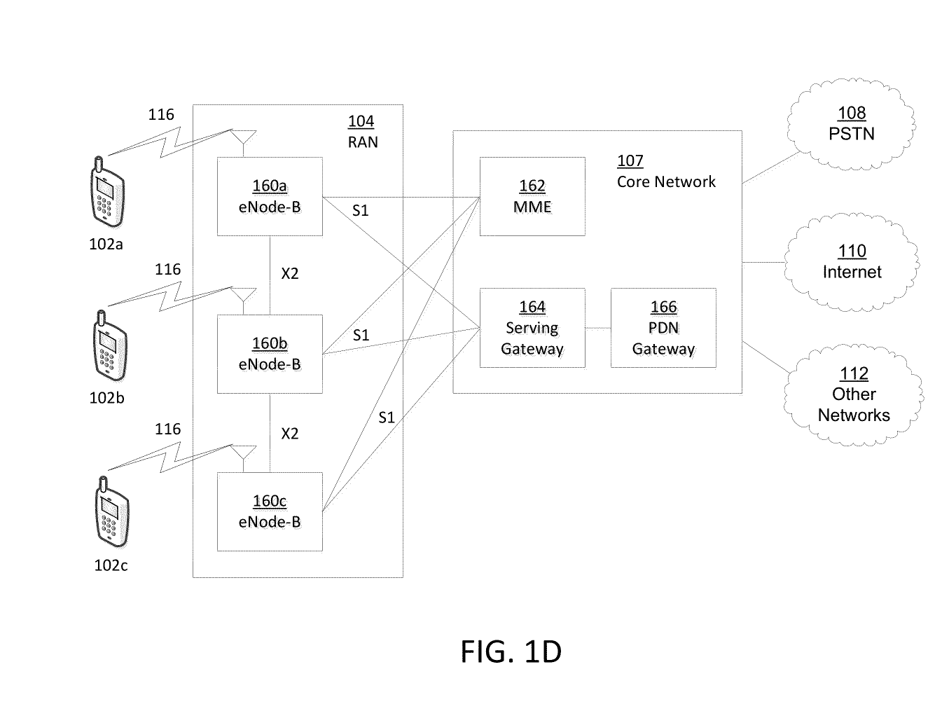

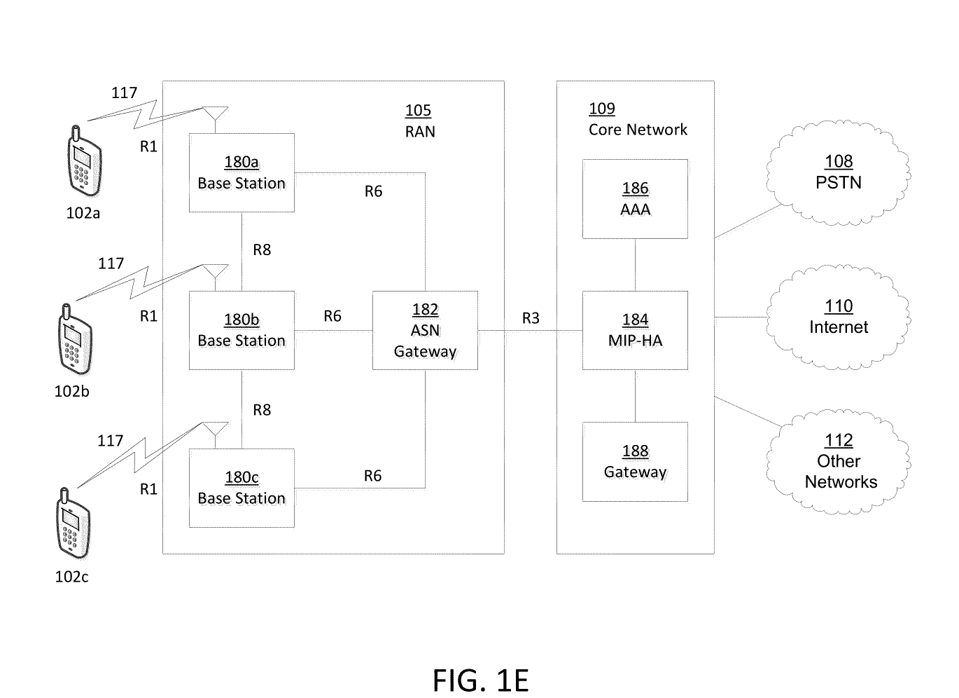

FIG. 1A depicts a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, and/or 102d may be any type of device configured to operate and/or communicate in a wireless environment. By way of example, the WTRUs 102a, 102b, 102c, and/or 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, and/or 102d to facilitate access to one or more communication networks, such as the core network 106/107/109, the Internet 110, and/or the networks 112. By way of example, the base stations 114a and/or 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a and/or 114b may communicate with one or more of the WTRUs 102a, 102b, 102c, and/or 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, and/or 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, and/or 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, and/or 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, and/or 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, and/or 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, and/or 102d in the communications system 100 may include multi-mode capabilities, i.e., the WTRUs 102a, 102b, 102c, and/or 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B depicts a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it may be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C depicts a system diagram of the RAN 103 and the core network 106 according to an embodiment. As noted above, the RAN 103 may employ a UTRA radio technology to communicate with the WTRUs 102a, 102b, and/or 102c over the air interface 115. The RAN 103 may also be in communication with the core network 106. As shown in FIG. 1C, the RAN 103 may include Node-Bs 140a, 140b, and/or 140c, which may each include one or more transceivers for communicating with the WTRUs 102a, 102b, and/or 102c over the air interface 115. The Node-Bs 140a, 140b, and/or 140c may each be associated with a particular cell (not shown) within the RAN 103. The RAN 103 may also include RNCs 142a and/or 142b. It will be appreciated that the RAN 103 may include any number of Node-Bs and RNCs while remaining consistent with an embodiment.

As shown in FIG. 1C, the Node-Bs 140a and/or 140b may be in communication with the RNC 142a. Additionally, the Node-B 140c may be in communication with the RNC 142b. The Node-Bs 140a, 140b, and/or 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, and/or 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and/or 102c with access to circuit-switched networks, such as the PSTN 108, to facilitate communications between the WTRUs 102a, 102b, and/or 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and/or 102c with access to packet-switched networks, such as the Internet 110, to facilitate communications between and the WTRUs 102a, 102b, and/or 102c and IP-enabled devices.

As noted above, the core network 106 may also be connected to the networks 112, which may include other wired or wireless networks that are owned and/or operated by other service providers.

FIG. 1D depicts a system diagram of the RAN 104 and the core network 107 according to an embodiment. As noted above, the RAN 104 may employ an E-UTRA radio technology to communicate with the WTRUs 102a, 102b, and/or 102c over the air interface 116. The RAN 104 may also be in communication with the core network 107.

The RAN 104 may include eNode-Bs 160a, 160b, and/or 160c, though it will be appreciated that the RAN 104 may include any number of eNode-Bs while remaining consistent with an embodiment. The eNode-Bs 160a, 160b, and/or 160c may each include one or more transceivers for communicating with the WTRUs 102a, 102b, and/or 102c over the air interface 116. In one embodiment, the eNode-Bs 160a, 160b, and/or 160c may implement MIMO technology. Thus, the eNode-B 160a, for example, may use multiple antennas to transmit wireless signals to, and receive wireless signals from, the WTRU 102a.

Each of the eNode-Bs 160a, 160b, and/or 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, and/or 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and/or 160c in the RAN 104 via an S1 interface and may serve as a control node. For example, the MME 162 may be responsible for authenticating users of the WTRUs 102a, 102b, and/or 102c, bearer activation/deactivation, selecting a particular serving gateway during an initial attach of the WTRUs 102a, 102b, and/or 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and/or 160c in the RAN 104 via the S1 interface. The serving gateway 164 may generally route and forward user data packets to/from the WTRUs 102a, 102b, and/or 102c. The serving gateway 164 may also perform other functions, such as anchoring user planes during inter-eNode B handovers, triggering paging when downlink data is available for the WTRUs 102a, 102b, and/or 102c, managing and storing contexts of the WTRUs 102a, 102b, and/or 102c, and the like.

The serving gateway 164 may also be connected to the PDN gateway 166, which may provide the WTRUs 102a, 102b, and/or 102c with access to packet-switched networks, such as the Internet 110, to facilitate communications between the WTRUs 102a, 102b, and/or 102c and IP-enabled devices.

The core network 107 may facilitate communications with other networks. For example, the core network 107 may provide the WTRUs 102a, 102b, and/or 102c with access to circuit-switched networks, such as the PSTN 108, to facilitate communications between the WTRUs 102a, 102b, and/or 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, and/or 102c with access to the networks 112, which may include other wired or wireless networks that are owned and/or operated by other service providers.

FIG. 1E depicts a system diagram of the RAN 105 and the core network 109 according to an embodiment. The RAN 105 may be an access service network (ASN) that employs IEEE 802.16 radio technology to communicate with the WTRUs 102a, 102b, and/or 102c over the air interface 117. As will be further discussed below, the communication links between the different functional entities of the WTRUs 102a, 102b, and/or 102c, the RAN 105, and the core network 109 may be defined as reference points.

As shown in FIG. 1E, the RAN 105 may include base stations 180a, 180b, and/or 180c, and an ASN gateway 182, though it will be appreciated that the RAN 105 may include any number of base stations and ASN gateways while remaining consistent with an embodiment. The base stations 180a, 180b, and/or 180c may each be associated with a particular cell (not shown) in the RAN 105 and may each include one or more transceivers for communicating with the WTRUs 102a, 102b, and/or 102c over the air interface 117. In one embodiment, the base stations 180a, 180b, and/or 180c may implement MIMO technology. Thus, the base station 180a, for example, may use multiple antennas to transmit wireless signals to, and receive wireless signals from, the WTRU 102a. The base stations 180a, 180b, and/or 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, and/or 102c and the RAN 105 may be defined as an R1 reference point that implements the IEEE 802.16 specification. In addition, each of the WTRUs 102a, 102b, and/or 102c may establish a logical interface (not shown) with the core network 109. The logical interface between the WTRUs 102a, 102b, and/or 102c and the core network 109 may be defined as an R2 reference point, which may be used for authentication, authorization, IP host configuration management, and/or mobility management.

The communication link between each of the base stations 180a, 180b, and/or 180c may be defined as an R8 reference point that includes protocols for facilitating WTRU handovers and the transfer of data between base stations. The communication link between the base stations 180a, 180b, and/or 180c and the ASN gateway 182 may be defined as an R6 reference point. The R6 reference point may include protocols for facilitating mobility management based on mobility events associated with each of the WTRUs 102a, 102b, and/or 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, and/or 102c to roam between different ASNs and/or different core networks. The MIP-HA 184 may provide the WTRUs 102a, 102b, and/or 102c with access to packet-switched networks, such as the Internet 110, to facilitate communications between the WTRUs 102a, 102b, and/or 102c and IP-enabled devices. The AAA server 186 may be responsible for user authentication and for supporting user services. The gateway 188 may facilitate interworking with other networks. For example, the gateway 188 may provide the WTRUs 102a, 102b, and/or 102c with access to circuit-switched networks, such as the PSTN 108, to facilitate communications between the WTRUs 102a, 102b, and/or 102c and traditional land-line communications devices. In addition, the gateway 188 may provide the WTRUs 102a, 102b, and/or 102c with access to the networks 112, which may include other wired or wireless networks that are owned and/or operated by other service providers.

Although not shown in FIG. 1E, it should, may, and/or will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, and/or 102c between the RAN 105 and the other ASNs. The communication link between the core network 109 and the other core networks may be defined as an R5 reference, which may include protocols for facilitating interworking between home core networks and visited core networks.

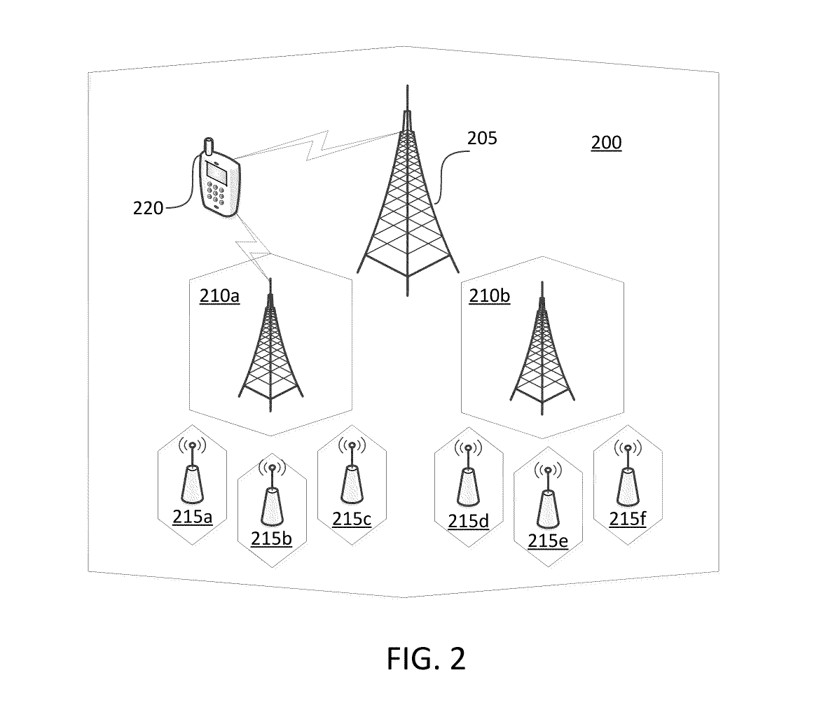

As described above, to increase capacity, a wireless operator may deploy a heterogeneous network. FIG. 2 illustrates an example embodiment of a heterogeneous network such as a heterogeneous network 200 that may be used herein. The heterogeneous network (e.g. 200) may include, for example, one or more layers of larger cells (e.g. macro cells) such as a cell 205 and/or one or more layers of smaller cells (e.g. pico cells, femto cells, and the like) such as cells 210a and 210b and/or cells 215a-c that may be used to provide communication to a UE such as UE 220. According to an embodiment, the coverage area of the smaller cells may be less than that of the larger cells. Additionally, the larger cells and smaller cells may or may not be operating on the same frequency layer. The cells (e.g. 205, 210a-c, and/or 215a-f) of the heterogeneous network (e.g. 200) may be part of one or more components of a communication network such as the communication network 100 described above including a radio access network, base station, and the like and may be in communication with a core network.

When operating on the same frequency layer or in a different frequency layer, a UE moving from or to the coverage area of a smaller cell (e.g. a pico cell) may perform a mobility procedure such as a handover from or to such a cell (e.g. from or to other cells such as other macro or pico cells) to allow the network to offload traffic from one cell to the other, maintain acceptable signal quality, since the signals from the larger cell (e.g. the macro cell) and the smaller cell (e.g. the pico) may interfere with each other. However, in some embodiments the handover may not be successfully performed using a current mobility procedure such as a handover.

For example, using the current mobility procedure, a UE may be quickly moving out the coverage of a serving cell (e.g. a smaller cell such as a pico cell) however, the UE may not be capable to handoff to the other neighboring cell due to a failure to receive a handover message on time before the quality of the serving cell degrades. The UE may have also moved out of the coverage area of a cell from which the handover may have originated (e.g. the cell from which the UE may have been handing over from). As such, in an embodiment, the UE may not have enough time to perform the handover thereby leading to a failure such as a radio link failure (RLF) using the current mobility procedure and may perform or invoke another mobility procedure such as a re-establishment procedure to connect to a cell.

Additionally, the current mobility procedures may include a mobility speed estimation that may be used to configure parameters for the handover. In such an embodiment, the UE may calculate or count the number of handovers that may take place during a time period or a particular amount of time to estimate the speed and, as such, scale or adjust parameters associated with the handover (e.g. faster or slower) to properly handle the handover. As such, =current mobility state estimation methods and/or procedures may include counting handovers over cells in homogenous networks (e.g. cells of similar sizes). However, such a speed estimation may not be suitable to scale or adjust the parameters (e.g. the parameters may be scaled the wrong way) when moving from smaller cells to bigger cells in the heterogeneous network as merely counting the number of handovers may not provide an accurate estimation of the speed.

In example embodiments, the heterogeneous network may also exhibit high signal strength variations and/or interference between a low power cell (e.g. the smaller cells) and other high power cells (e.g. the larger cells). Such an interference situation may affect current mobility procedures and may compromise the quality of the DL signal thereby increasing the probability of a failure to receive messages from the serving cell. For example, one or more low power nodes may be located inside buildings or other structures, and, thus, may cause a UE to experience a large variation of signal strength in a short time due to the removal or addition of the indoor penetration loss as the UE moves into or out of the building or structure. When the low power cell operates on the same frequency as the source cell, the signal strength variation from the low power cell may increase the probability of failure for the handover procedure to or from this low power cell. Additionally, in embodiments, the signal strength that maybe be received from the high power cell may over power the signal received from a serving cell such as a serving pico cell and, thus, may interfere (e.g. severely) with a DL signal of the service cell such as the serving pico cell. In such an embodiment, a failure may occur such that messages including handover messages may not be received by the UE on the serving cell, for example. Additionally, the UE may declare a radio link failure before being able to either successfully deliver a measurement report or before having triggered a measurement report (e.g. as part of the mobility procedures). Often these conditions cause the UE to move back to idle mode and restart the connection establishment procedures or perform a re-establishment procedure.

As such, current mobility procedures may not be suitable for use in a heterogeneous network as described above and as the cells in the heterogeneous network may provide a robustness situation or a potential robustness situation (e.g. may lead to or may potentially lead to a failure or radio link failure as described above or a ping-pong when the UE moves between cells (e.g. two cells) quickly or fast) when performing the current mobility procedures. To provide mobility robustness in mobility procedures and/or parameters in a heterogeneous network, the systems and/or methods disclosed herein may be used. For example, a mobility robustness action may be performed, invoked, and/or applied to mitigate or reduce failures that may occur with current mobility procedures. According to an example embodiment, such a mobility robustness action may be performed, invoked, and/or applied after detecting, identifying, and/or determining that a network may have one or more cells that may cause or provoke a robustness situation as described herein. Additionally, in current deployments and UE operations the UE may not be aware of the size of the cells (e.g. whether a cell may be a small or large cell). For example, the UE may performs signal strength measurements upon detection of the cell and may not distinguish whether the cell may be a small or large cell. In such an embodiment (e.g. without knowledge of whether a cell may be a small cell or a large cell), current deployments and/or UE operations (e.g. methods thereof) may further not be suitable to handle a handover between cells of different sizes.

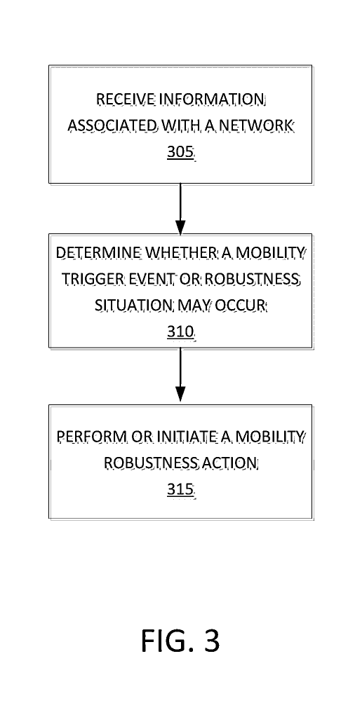

FIG. 3 illustrates an example embodiment of an example method for providing mobility robustness in a heterogeneous network such as the heterogeneous network shown in FIG. 2. According to embodiments, the example method in FIG. 3 and/or additional example methods or procedures disclosed herein may be applied to a handover to a cell or to a data plane and/or to a switching of a secondary cell (e.g. the primary cell may be kept but the secondary cell may change.

As shown in FIG. 3, information associated with a network may be received at 305. For example, a UE may receive information associated with or from a network that the UE may be connected to and/or surrounded by small and larger cells. The UE may be configured (e.g. explicitly) and provided the information associated to the neighboring cells (e.g. whether the cells may be smaller cells or larger cells). Such information may include information associated with cells in the network such as a physical cell identity (PCI) and/or configurations of the cells (e.g. that may be used to determine whether the cell may be included in a network that may have cells of the same size or different sizes). For example, the network may provide the UE with a set of PCIs that belong to cells of a configured size (e.g. small cells). When a PCI corresponding to the configured list may be detected by the UE, the UE may determine that the cell may be a smaller cell (e.g. a pico cell, a femto cell, and the like) and/or of a size as provided in the configuration. The network may also configure the UE with measurement or configuration information associated with the UE and/or network, other information that may indicate the deployment of the network including whether the network may be heterogeneous, and, thus, may have different cell sizes, and the like. As such, at 305, the UE may receive information or details indicative of the network to which it may be connected or to which it may be establishing a connection including the deployment or implementation of cells or other components included in the network.

At 310, a determination may be made regarding whether a robustness situation (e.g. a situation as described above that may lead to failure of a handover or radio link failure) may occur (e.g. may exist or may potentially exist based on the received information) and/or whether to trigger a mobility robustness action (e.g. based on the received information).

For example, at 310, the UE may determine, detect, and/or identify whether it may be in proximity to at least one cell (e.g. a proximity mobility trigger) that may be identified as a potential target cell that may cause or provide robust mobility behavior or a robustness situation, for example, based on the received information. Such cell may be a “mobility robust cell” (e.g. a cell for which mobility robustness procedures or methods may be applied to). The UE may apply a mobility robustness action (e.g. at 315 described below) if the UE may be entering proximity to at least one mobility robust cell, and may unapply (or stop) the mobility robustness action if the UE may be leaving proximity of a mobility robust cell.

In one embodiment, to determine whether a cell may be a mobility robust cell, the UE may compare a PCI that may be received (e.g. at 305) with a set or list of PCIs that may be identified or reserved as mobility robust cells. For example, the information received, at 305, may include a PCI for a cell. The UE may then, at 310, compare the received PCI with a set or list of PCIs that may have been provided to the UE in advance (e.g. by higher layers and/or possibly by specifying a range of PCI values). If or when the received PCI may be included in the set or list of PCIs identified or reserved as mobility robust cells, the cell may be marked or an indication may be generated and/or provided that the cell may be a mobility robust cell (e.g. and, thus, a robustness situation may occur). As such, in an embodiment, the UE may determine that a mobility robustness action may be performed, initiated, used, and/or applied based on whether the source and/or target cell may be a small cell or not. For example, mobility robustness actions may be performed, initiated, used, and/or applied, if one or a combination of the following may be detected: the source cell may be determined to be a small cell; the target cell may be determined to be a small cell; the source cell may be a large cell (e.g. a macro cell) and the target cell may be a small cell; the source cell may be a small cell and the target cell may be a large cell (e.g. a macro cell); both the source and target cells may be small cells. As described herein whether the target or source cell are macro or small cells may be based on higher layer configuration and associated PCIs for example.

According to an example embodiment, as described above, after determining whether a cell may be a mobility robustness cell, the UE may further determine, at 315, whether the UE may be in proximity of the mobility robustness cell such that a robustness situation may occur (e.g. and, thus, may invoke, apply, or perform a mobility robustness action at 315, which will be described in more detail below). To determine whether the UE may be in proximity of the mobility robust cell (e.g. such that a robustness situation may occur), the UE may determine whether a measurement (e.g. a L3 measurements such as RSRP or RSRQ of the mobility robust cell may be above a threshold, may determine whether a measurement (e.g. the L3 measurement) of the mobility robust cell may be larger than the corresponding measurement of a source cell (e.g. by an offset), may determine whether a measurement (e.g. the L3 measurement) of a serving cell may be below a threshold, may determine whether a measurement (e.g. the L3 measurement) of a neighboring cell may be larger than corresponding measurement of a mobility robust cell, may determine whether a geographic position (e.g. obtained using GPS) may indicate the UE may be in proximity of a least a mobility robust cell, may determine whether macro cell PCI may indicate the UE may be in proximity of the mobility robust cell, and the like. The offset and/or threshold, in example embodiments, may be provided by higher layers. For example, the offset and/or threshold may be provided as part of a measurement configuration for the UE (e.g. that may be provided at 305, for example, as part of the information).

In further embodiments, the network may indicate (e.g. explicitly) whether a robustness situation may occur and/or whether to trigger a mobility robustness action at 310. For example, the information (e.g. received at 305) may provide an indication to the UE that a robustness situation may occur in particular locations, time periods, and/or other circumstances and/or when to trigger a mobility robustness action in particular locations, time periods, and/or other circumstances. At 310, the UE may then determine whether the UE may be in the particular locations, time periods, and/or other circumstances provided by the information and/or indications. For example, in one embodiment, such information may provide an indication to the UE that a robustness situation may occur and/or to trigger a mobility robustness action when entering a specific region or cell. In embodiments, he network may also indicate in the information the mobility robustness action for the UE to take at 315, which will be described in more detail below. For instance, the UE may be provided with a report configuration (e.g. at 305) specifying the type of trigger and associated parameters along with an indication that the configuration is applicable to the triggering of a particular mobility robustness action, the UE may then determine whether the trigger and/or parameters may exist in the UE at 310, and the UE may then apply the particular mobility robustness action at 315, which will be described in more detail below.

Additionally, at 310, the UE may determine, detect, and/or identify whether the UE may be in a particular time period that may trigger a mobility robustness action (e.g. a trigger based on initiation of mobility) and/or that may cause a robustness situation. For example, the UE may determine whether to apply a robustness action at a certain time prompted, for example, by a measurement report that may trigger a handover to a mobility robust cell (e.g. a “concerned measurement report” that may generate a “measurement report mobility trigger”). In an embodiment, the mobility robustness action may start (e.g. at 315) at one or more following times (e.g. that may be determined at 310): upon triggering of a concerned measurement report; upon the start of a transmission of a concerned measurement report; upon reception of an acknowledgment from the network that the concerned measurement report may have been successfully received (e.g. at physical layer or RLC); upon expiration of a timer (e.g. started at one of the above events); and the like.

In additional embodiment, when determining (e.g. at 310 whether to apply a mobility robustness action (e.g. at 315), the UE may stop a mobility robustness action when one or more of the following events occurs: when a timer may expire (e.g. a timer that may have been started when the UE began applying a mobility robustness action may expire); when the UE may receive a RRC message a reconfiguration message, a handover (e.g. a reconfiguration with mobilityControlInfo IE) message, a handover where the target cell may be a “mobility robust cell,” a RRC connection release message from the network; when the UE may complete (e.g. successfully) a handover to a “mobility robust cell,” when no mobility robust cells may be detected in the vicinity, and the like.

As described herein, the UE may use measurement events (e.g. that may be detected or determined at 310) related to neighbor cell quality to trigger a mobility robustness action such as target cell pre-configuration procedures. Thus, a measurement mobility trigger (e.g. that may be determined and/or detected at 310) may result from measurement events such as when a neighbor cell channel quality may be greater than (e.g. above) a threshold; when a source cell may be less than (e.g. below) a threshold, when a new measurement event that may be used to report when a second best cell changes may occur, when a measurement report may be triggered when a neighboring cell may enter a reporting range, when a measurement report that may be used to maintain a set of N best cells may be triggered when a neighboring cell becomes better than one or more of the N best cells, and the like. In example embodiments, these events may be used independently or in combination with the triggers described above to determine whether to initiate and/or request a mobility robustness action (e.g. at 315) such as a target cell pre-configuration procedure, which may be described in more detail below.

If or when, based on the determination at 310, a robustness situation may occur and/or mobility robustness action may be triggered, a mobility robustness action (e.g. that may mitigate and/or reduce the robustness situation) may be applied, performed, initiated, and/or invoked at 315. For example, a first mobility robustness action may be applied, performed, initiated, and/or invoked at 315. In the first mobility robustness action, a UE may be pre-configured with target cell information (e.g. prior to a change of a best cell) such that the probability of handover success may be increased, the delay associated handover procedure may be minimized, and/or the probability of successful re-establishment is increased. For example, the UE may be pre-configured with target cell information that may be used to perform a handover to a target cell before a handover measurement event may be transmitted or before a handover decision may be made. The information that the UE may be pre-configured with may be described herein below.

According to an example embodiment, a pre-configuration procedure may be initiated (e.g. at 315) as a result of a trigger (or determination of a potential robustness situation in the UE) (e.g. at 310). As a result of a triggering condition being met or a robustness situation occurring (e.g. as described above at 310), the UE may send a report to a source eNB that may then determine to initiate a target cell pre-preparation procedure at 315. The target cell pre-preparation may include the target cell pre-allocating resources and configuring a UE context before a handover may be triggered by the source and/or target. The procedures and mechanisms in which a target cell may be pre-prepared may be described in more detail below.

The target cell pre-prepared resources or a subset thereof may then be communicated to the UE in the form of a target cell pre-configuration. Upon reception of a target cell pre-configuration, the UE may store such information and may use the information at a later time when a handover or Radio Link Failure (RLF) may occur (e.g. may be triggered or determined to potentially occur at 310) or at a time when the pre-configured cells may be or may become the best cell. According to additional embodiments, to allow the UE to perform the handover at the right time using the pre-configured information and to increase the robustness of the handover command by allowing its transmission by both the source cell and the target cell. UE actions with respect to the use of this configuration and target cell monitoring are described in more detail below.

Alternatively, the pre-configuration procedure may be initiated prior to a trigger being met or a determination of a robustness situation (e.g. at 310). For example, the pre-configuration procedure may be initiated when the UE may connect to the network or a cell such that the pre-configuration information may be received by the UE prior to detecting or determining a trigger or potential robustness situation (e.g. at 310) such that when a trigger (e.g. a cell may be a mobility robust cell) may be detected or robustness situation may be determined or detected (e.g. at 310), the UE may apply the pre-configuration information (e.g. at 315) when performing, for example, a handover.

In one embodiment, a mobility robustness action (e.g. that may be applied, performed, invoked, and/or initiated at 315) may include configuring the UE with target cell information prior to a handover procedure being executed. The target cell pre-configuration information may be stored in the UE and may be applied at a later time (e.g. at 315) such as once a handover may be triggered and/or commanded by the UE or upon a radio link failure (RLF) (e.g. that may be detected and/or determined at 310).

According to example embodiments, the target cell pre-configuration information may include at least a subset of the information that the UE may use to perform (e.g. successfully) a handover or connect to a target cell including, for example, physical layer parameters, MAC parameters, and the like. As such, in embodiments, the target cell pre-preparation information may include the pre-allocation of one or more of the following parameters (e.g. one or more of a combination or subset for a UE): a configuration of physical layer resources such as a PDSCH configuration, a PUCCH configuration, a PUSCH configuration, uplink power control information, a TPC DPCCH configuration (e.g. TPC DPCCH configuration (PUSCH and PUCCH)), a channel quality indicator (CQI) report, a sounding resource element (RE) uplink configuration or information, antenna information, a scheduling request (SR) configuration or information, and the like; mobility control information for a target cell such as PCI, frequency information, bandwidth information, SIB related information (e.g. RadioresourceconfigCommon such the UE may not have to read the SIBs and stop the current connection), C-RNTI, and the like; a dedicated preamble that the UEs may use when accessing a target cell or attempting a handover (e.g. when the triggers to perform mobility may be met or when a UE attempts an enhanced re-establishment procedure) such as RAC-configDedicated including PreambleIndex and/or PRACH maskIndex; a security configuration including the nextHopChainingCount of a target cell that may be included in the re-establishment message (e.g. if a security algorithm change may be performed or used in a target cell), a MAC configuration, a SPS configuration that may be used in a target cell, NAS information such as a DedicatedinfoNAS list, radio resource configuration (RRC) information (e.g. dedicated) such as a SRB services including a SRB-toaddmodify list and/or DRB services including a DRB-toaddmodlist, a DRB-torelease; a DRX configuration or information; a target cell ABS pattern or measurement restriction; and the like. Additionally, the target cell pre-configuration may include a pre-configuration of small cells to be used together with a macro cell (e.g. to allow or enable simultaneous reception over both cells). When such a cell may be pre-configured, a subset of the information may be used as the macro cell may still be in charge of the bearer and RRC connection and an indication that the UE may be simultaneously receiving over these cells.

A further robustness action (e.g. that may be applied, performed, invoked, and/or initiated) may include a pre-handover target cell configuration procedure. In such an embodiment, a target cell may be preliminary prepared for a handover that may occur in at a subsequent time (e.g. in the near future). In such an embodiment, a source cell may indicate (e.g. may provide an indication or information that may indicate) to the target cell that such resources may be reserved for a subsequent or future handover and that no handover may be currently taking place. The target cell may then prepare and reserve a set of resources that may be used by the UE to make the initial connection. As such, a target cell pre-preparation procedure or method may be a procedure or sub-procedure associated with a source cell that may initiate a request to pre-prepare a UE and/or a target cell for a handover that may take place at a later time (e.g. a subsequent handover). The target cell may pre-establish resources for a UE for a potential future handover (e.g. which may or not be an incoming handover).

For example, as described herein, the UE may monitor (e.g. continuously) triggering conditions. When one or more of the triggering conditions may be met a report may be sent to notify the network that a mobility robustness action such as the pre-handover procedure may be initiated. Upon reception of the report and/or a determination of to initiate the mobility robustness action such as the pre-handover procedure, the network (e.g. the source eNB or BS) may the initiate the mobility robustness action such as the pre-handover target cell configuration procedure in either or both of the UE and target cell. Alternatively, when a UE may enter a source cell, the source cell may autonomously determine that the UE should be pre-configured with neighbor cell information and may initiate such a pre-handover procedure.

In one embodiment, the target cell pre-preparation procedure may include a pre-allocation of one or a combination or a subset of the parameters described above. For example, the target cell may pre-prepare a subset of parameters such as, for example, the physical layer resources, MAC resources, SPS resources, mobility information, a dedicated preamble, or common system information. In such an embodiment, a SRB and/or DRB negotiation and preparation may not be performed until an actual handover may be initiated by either a source cell or a target cell. Once the triggers to perform a handover may be met the source cell may initiate a full handover preparation procedure where the radio bearers, security, NAS level procedures, and the like may be performed. The handover message (e.g. the new handover message) that may be sent to the UE may include the new information that may not have been originally provided to the UE as part of the pre-configuration information such ast signaling, data radio bearer configurations, and the like.

In an alternative embodiment, each of the parameters described above may be (e.g. a full) configuration may be pre-prepared and provided to the source cell and to the UE. In such embodiment, the data and signaling radio bearers, NAS parameters and security, including physical layer, MAC, common system information, and the like may be pre-allocated and pre-configured in the UE.

In another embodiment, the mobility information may be pre-prepared and provided to and by the source cell and to the UE. The mobility information may include a subset of parameters or configuration information that the UE may use to efficiently connect to the target cell for a RACH procedure to perform a handover (e.g. a successful handover). Such information may include, for example, PCI and/or frequency information associated with a target cell, bandwidth or bandwidth information; SIB and/or MIB related information (e.g. RadioresourceconfigCommon) so the UE may not have to read the SIBs and stop the current connection with the source cell or the UE may connect to the target cell even under strong interference situation where it may not be able to read the SIB/MIB information, C-RNTI that may be used once connected to the target cell, a dedicated preamble (e.g. RACH-configDedicated), and the like. Additionally, in such an embodiment, the remaining handover information that will allow the UE to fully connect to the target cell may be provided to the UE at a later stage. In embodiments, at least a portion of the information described herein may be provided to the UE as part of the handover message, for example, after the target cell may have been prepared for the handover. Additionally, the information described herein that may be given or provided to the UE in addition to the information typically provided in the handover message may be the MIB/SIB information that may be used to connect to the target cell and initiate a RACH procedure. This may enable or allow the UE to have the appropriate MIB/SIB information for enabling or allowing the UE to complete the handover procedure (e.g. successfully).

In a further embodiment, a default SRB configuration may be provided or pre-configured in the UE to allow the connection and handover message to be transmitted over the target cell.

As described above, the information or parameters that may be used for pre-preparing the UE for a handover (e.g. may be pre-configured in the UE) may be stored in the UE until a handover may be initiated. However, given the uncertainty of when the UE may perform a handover to a particular target cell or if the UE may perform a handover to a particular target cell, in some embodiments, it may be undesirable for the UE to store at least some of the information such as the dedicated preamble for an indefinite period of time. As such, to avoid wasting PRACH resources, the UE may temporarily store and use at least some of the information such as the dedicated preamble. For example, at least some of the information such as the dedicated preamble configuration for a target cell may be deleted from the UE when one or more the following criteria may be met: a timer such as a maximum dedicated preamble timer may expire that may be configured or predefined in the UE and/or the UE may not have performed a handover to a corresponding target cell from the time of the information such as dedicated preamble pre-configuration to the expiration of the timer; a target cell pre-configuration may be deleted from the UE; a new pre-configuration message for the target cell may be provided to the UE; the triggering conditions for stopping the target cell pre-configurations may not be met; and the like.

According to an embodiment, the target cell may pre-configure or pre-prepare-prepare resources for the UE as described herein and may provide the information or parameters (e.g. to a source cell) that may be used to pre-configure or pre-prepare the resources using X2 or S1 signaling. Additionally, in embodiments, the target cell may prepare a RRC message that may include the target cell pre-configuration parameters to be sent to the UE. Such an RRC message may correspond to an existing RRC message and may include an indication that the given may be a target cell pre-configuration rather than a handover command. Additionally, such an indication may be in the form of an information element (IE) (e.g. a new IE) that may include the configuration parameters and/or an explicit target cell pre-configuration bit (e.g. that may be set if the configuration may be a target cell pre-configuration, otherwise (e.g. not set) for a normal handover procedure). Alternatively, another RRC message (e.g. a new RRC message) may be defined to carry such information to the UE and/or may be relayed to the source cell over a transparent container and sent to the UE, for example, as an RRC message. Upon reception of a pre-configuration message, the UE may store the information of the target cell as described above and/or store the particular message received associated to the target cell such that the UE may use this information (e.g. the target cell pre-configuration information) when one or more criteria may be met as described herein, as a result of a handover to the target cell, when a re-establishment to a pre-configured target cell may be attempted by the UE, and the like.

In one embodiment, mobility robustness may be increased by monitoring for a handover command over either the source cell and/or over the target cell. For example, the network may send a handover command over the source and/or target cells to increase probability of proper reception of the handover command in the UE (e.g. to reduce chances that the handover command may not be received when the UE may be moving between cells in the network). In such an embodiment, the UE may start monitoring both the source and target cell for a handover command, for example, upon triggering a measurement report, requesting a change of serving cell to a target cell (e.g. event A3), and the like.

In example embodiments, the handover command that may be provided or over the target cell (and/or the source cell) may be provided using one or more of the following (e.g. may correspond to one or more of the following): a layer message such as a layer 1 message, a MAC control element that may indicate to the UE that the UE may perform a handover using the pre-configuration for the target cell, a RRC reconfiguration message (e.g. the full RRC reconfiguration message), and the like.

To receive a command over the source and/or target cells, the UE may have a dual receiver that may enable the UE to simultaneously monitor the source and target cell and/or a subset of the target cell channels.

Alternatively, the UE may monitor one cell at a time using, for example, time division multiplexing (TDM) techniques. According to example embodiments, the target and/or source cell may be monitored at a particular time. The time to monitor the target cell may be based on or determined based on at least one of the following: a DRX pattern (e.g. the UE may monitor the source cell during an active time and the target cell during the inactive time of the DRX pattern); a pattern that may be explicitly configured for target cell monitoring; at a predetermined or predefined time or period of time (e.g. the UE may start monitoring the target cell and may stop monitoring the source cell at a predefined period of time after the measurement report may have been successfully transmitted and/or the UE may monitor the target cell for a maximum time duration to receive a handover command and if a handover command may not be received during this time, the UE may switch back to the source cell and continue normal operation); and the like.

In such embodiments (e.g. simultaneous monitoring or monitoring one cell at a time as described above), the UE may monitor the target cell for a maximum time duration after which the UE may fall back to the source cell and may continue normal operation.

According to additional embodiments, the UE may disconnect from the source cell and start monitoring the target cell as described above when one or more of the following conditions may be met: a handover command may not be received on a source cell for a configured period of time, a particular quality of the source cell may be obtained (e.g. a RSRP or RSRQ may be below a threshold); a Qout may be detected on the source cell, a radio link failure (RLF) may be declared on the source cell (e.g. after a measurement report may have been transmitted), the UE may include a target cell pre-configuration for a candidate best cell, and the like.

In an embodiment, if a handover command may be received from the source cell, the UE may perform the handover using typical handover procedures (e.g. normal legacy procedures) such as using the information provided in the RRC message received indicating to perform a handover.

Alternatively, if the handover command may be received from the target cell, the UE may perform a handover to the target cell using the preconfigured or pre-prepared information and may send an RRC reconfiguration. For example, upon reception of the handover command, the UE may process the stored configuration message for the target cell. The UE may then use the configuration of the target cell to perform a handover and initiate an uplink procedure. For example, in an embodiment, a RACH procedure may be initiated to the target cell using the dedicated preamble (e.g. if available and stored for the particular target cell). If a dedicated preamble may not be available (e.g. in the pre-configured information or system information), the UE may start a random preamble procedure using the information provided by the pre-configured information (e.g. the pre-configured common system information). Additionally, according to an example embodiment, if a C-RNTI may be available in the pre-configuration, the UE may start using the C-RNTI to receive scheduling information such as a downlink scheduling.

The UE may then send a RRC reconfiguration (e.g. a RRC reconfiguration complete) to the network and/or a RRC message (e.g. a new RRC message) that may acknowledge the reception of the handover indication from the target cell. In the RRC reconfiguration and/or message, the UE may append a UE ID (e.g. C-RNTI and/or a short MAC-i to enable the network to authenticate and identify the UE). Additionally, in an embodiment, the UE may add an indication such as an explicit indication that the message may have been triggered as a result of a handover command from the network. If a subset of the pre-configuration parameters may be provided to the UE as described above, the target cell may provide one or more of the remaining parameters such as DRB, SRB, NAS, security information, and the like to the UE over the target cell in a RRC message such as a RRC reconfiguration message. Once this message may be received by the UE, the handover may be complete in the UE.

In another embodiment, the pre-configuration (e.g. that may be applied, performed, initiated, and/or invoked at 315) in the UE may be used to perform a faster re-establishment in the event that a RLF may occur in the UE. For example, if a RLF may have occurred prior to the UE sending a measurement report to the network and a selected cell may correspond to a pre-configured target cell, the UE may perform a fast re-establishment procedure or method that may reduce the latency of a re-establishment procedure since the target cell may have pre-prepared the UE (e.g. the UE context). Additionally, if at least a subset of system information and/or parameters may be provided to the UE (e.g. MIB/SIB1 or SIB3), the amount of time to read a SIB for the target cell may be reduced and/or a RACH procedure may be performed faster if a dedicate preamble may still be available.

For example, according to an embodiment, a dedicated stored preamble may be used to perform an uplink (UL) access (e.g. if available) and the stored configuration parameters may be used to connect to the cell when starting or performing a fast re-establishment procedure (e.g. when a RLF may occur and the UE may reselect to a pre-configured cell). To speed up the authentication and identification of the UE, the UE may append a pre-allocated C-RNTI to existing parameters in a RRC message. The UE may also include the source cell identity in the re-establishment message. Alternatively, in an embodiment, the target cell may identify the UE from the dedicated preamble that may be used.

Once the target cell may identify the UE and the source cell, the target cell may initiate a handover or context transfer. If the resources may have been pre-configured (e.g. a full configuration), the target cell may immediately provide the preparation information and a list of radio bearers to transfer to the source cell.

The RRC reestablishment message that may be sent to the UE may include the additional information or parameters that the UE may not already have already (e.g. the parameters that may not have been pre-configured) such that the UE may have a full set of configuration information or parameters. Alternatively, if the UE may have the full set of configuration information or parameters pre-configured, an indication approving the use of the already stored pre-configuration parameters may be sent to the UE. Additional security parameters or information may be provided to the UE in the re-establishment message.

In embodiments described herein, a UE may be further pre-configured with target cell information prior to a change of best cell such that the probability of handover success may be increased, the delay associated handover procedure may be reduced minimized, and/or the probability of successful reestablishment may be increased. When pre-configuring the UE with target cell information prior to a change of best cell, a report that may indicate when such target cell pre-configuration should be triggered may be provided to the network, the target cell for a potential upcoming handover to the UE may be pre-prepared, the information and/or parameters may be provided to the UE, and the pre-configured information may be used and a handover may be performed when the right time comes as described herein.

Additionally, in embodiments, the UE may remove or delete the target cell pre-configuration (e.g. that may be applied, performed, initiated, and/or invoked at 315). For example, the UE may remove or delete the target cell pre-configuration when one more of the following criteria may be met: a trigger to start a mobility robustness action may no longer be met, the network may indicate (e.g. explicitly) to the UE to remove to pre-configuration, the pre-configuration may not be used for a predetermined or predefined period of time (e.g. the pre-configuration may have been stored, but not be used for a particular period of time), a change of second best cell may occur in the UE, a quality of the target cell may change (e.g. may go below a threshold), and the like. When the conditions to delete or remove the pre-configuration are met (e.g. after determining that one or more of the criteria may be met), the UE may delete the pre-configuration and/or may notify the network of the removal of the pre-configuration.

Another mobility robustness action (e.g. a second mobility robustness action) that may be performed, applied, initiated, and/or invoked (e.g. at 315) may include an active time extension. For example, in such embodiment, a UE may be configured (e.g. at 315) with discontinuous reception (DRX) to extend its Active Time (e.g. the subframes during which PDCCH may monitored) to one or more subframes, that may not have been part of the Active Time in existing DRX rules or protocols. The inclusion of additional subframes in the Active Time may reduce the latency of the mobility procedure such as the reception of a handover command after the UE may have transmitted a measurement report to the network indicating a change of best cell, and, as such, may increase the probability of successful reception of the command. The UE may initiate the extension of the active time as soon as a trigger for mobility robustness may be met (e.g. as soon as the measurement report indicating a change of best cell may be transmitted or another trigger or robustness situation may be detected or determined to be met at 310) and/or the extension of the active time may be initiated a predefined time after a trigger for mobility robustness may be met.

The extension of the active time may be performed by modifying the DRX rules. For example, when the extension may take effect a new timer may be started and an additional DRX rule may stipulate that the active time may include the time when the new timer may be running Alternatively, in an embodiment, an additional rule may stipulate that a Short DRX cycle (or a newly defined DRX cycle) may be used while the new timer may be running The value of the new timer and possibly other parameters may be predefined, or provided by higher layers (e.g. in advance) by higher layer signaling such as in a new or existing information element (IE) of the DRX configuration.

For example, in an embodiment, upon transmission of a measurement report or after configured TTIs, the UE may move to continuous PDCCH or ePDCCH reception for a certain period of time. If the handover command may be received, the UE may perform the handover to the target cell and may fall back to normal DRX operations as configured. If the timer may expire and no handover command may be received, the UE may go back to DRX operation where the OnDuration and active time may be determined per one or more rules (e.g. legacy rules). Additionally, the active time extension may be applied during a change of best cell procedure if configured by the network or it may be applied if the UE may detect that the change to or from the best cell may be a mobility robust cell or if the UE may be in a mobility robust scenario or situation or action as described above.

A further mobility robustness action that may be performed, applied, initiated, and/or invoked (e.g. at 315) may include application of an almost blank subframe (ABS) pattern. For example, in such an embodiment, a UE may be configured to use an ABS pattern for radio link monitoring, L3 measurements, and/or CSI measurements. The ABS pattern may be provided (e.g. in advance) to the UE through RRC signaling. The application of the ABS pattern for may further enhance the robustness of the link and may increase the probability of successful reception of a handover command even if the target cell may be stronger than the source cell.

In one embodiment, the ABS pattern may be provided to the UE as part of the target cell pre-configuration. The UE may then use the pattern to facilitate reestablishment to a cell (e.g. a larger cell such as a macro cell). The re-establishment procedures may follow the methods described herein. For example, the UE may indicate the use of the pattern in the reestablishment request such that the cell may schedule the re-establishment message during a ABS associated with another cell.

Another mobility robustness action that may be performed, applied, initiated, and/or invoked (e.g. at 315) may include modification of a measurement or measurement configuration. For example, a UE may be configured by modifying at least one parameter of a measurement configuration associated with the UE, for example, to accelerate the transmission of a measurement report that may be used to trigger a handover. In such an embodiment, the UE may modify at least one of the following parameters associated with a measurement or measurement configuration: a time to trigger parameter that may be provided in a report configuration where a smaller value or shorter time may result in earlier transmission of a measurement report, speed state parameters such as a scaling factor that may be used to scale a mobility control parameter (e.g. a time to trigger parameter), a cell offset parameter that may be used in certain types of events such as A3 (e.g. a change of best cell) or A6 where a smaller and even negative value may result in earlier transmission of the report, a L3 filtering coefficient (k), and the like.

The modification of the measurement configuration may be performed by activating a pre-defined or pre-configured measurement (e.g. that may be identified by a measId) and/or a report configuration and/or also de-activating or removing another report configuration or measurement that may include the original parameters. In one embodiment, the UE may associate two report configurations to a given measurement including a first report that the UE may use when not applying a mobility robustness action and a second report that the UE may use when applying this mobility robustness action. Additionally, the modification of the measurement configuration may be applied to a given or particular measurement configuration by scaling one or a subset of the measurement parameters discussed above based on the determination of whether a mobility robustness action may be performed or not. For example, the UE may determine that a mobility robustness action may be performed based on whether the source and/or target cell may be a small cell or not. In such an embodiment, the UE may determine which configuration to use based on the mobility robust scenario or situation or action described herein. For example, if a source cell may be a mobility robust cell, the UE may use a particular configuration parameter, if the target cell may be a mobility robust cell the UE may use another configuration parameter, if the source cell may be large (e.g. macro) and the target cell may be small (e.g. a pico), or vice versa, the UE may chose the corresponding configuration. The mobility robustness scenario or mobility robustness action or situation in which a configuration may be used may be configured in the measurement configuration by the network or may be predefined in the UE as described herein. Additionally, as the determination of the type of cell may be based on PCI, the choice of configuration parameter may also depend on the PCI of the target and/or source cell. For example, if the PCI of the target cell (or if the PCI of the source cell) may belong to a configured list, the UE may use the mobility robust configuration, otherwise it uses the other normal configuration.

Another mobility robustness action that may be performed, applied, initiated, and/or invoked (e.g. at 315) may include modification of a “mobility state.” For example, a UE may be configured by modifying its “mobility state” to a state reflecting a higher mobility state such as “high mobility” or “medium mobility.” Such a modification of the mobility state may enable or allow the UE to apply speed-dependent scaling of certain mobility control parameters including a time to trigger that may result in an earlier transmission of a measurement report. In an embodiment, the UE may also use different rules for the determination of the “mobility state” that may increase the likelihood of determining a higher mobility state. Alternatively, a new “mobility robustness” state may be defined where a “mobility robustness” scaling of certain mobility control parameters may be configured and applied. According to example embodiments, the modification of the mobility state may be performed according to one or more of the following: by setting the mobility state to a pre-defined or pre-configured state irrespective of other rules that may be for setting the mobility state; by using a different set of parameters for the determination of the mobility state such as a maximum number of cell reselections and/or handovers to enter a particular state and/or a duration for evaluating the number of cell reselections/handovers (e.g. where such different sets of parameters may have been provided to the UE, for example, in advance by higher layer signaling); and the like. As described in the method above, depending on the mobility robustness scenario or situation or action, the UE may determine that it is in the “mobility robust state”. For example, if the target cell or PCI of the target cell belongs to the mobility robust cells the UE may apply the new mobility state, else the UE applies the normal mobility state as determine by the estimation procedure.

As described herein, the UE may indicate to the network that the UE may be applying at least one of the mobility robustness actions described above (e.g. extending its active time, applying ABS pattern, modifying its report configuration or mobility state, and the like). Such an indication may be provided in a RRC, MAC or physical layer message or signal. For example, the indication may be included as part of a measurement report that may trigger a handover (e.g. a measurement report triggered by a “change of best cell” event). Additionally, the indication may be included in a proximity indication message or in another message indicating that the UE may be near a particular cell (e.g. a smaller cell such as pico cell or femto cell). The UE may also indicate to the network that it may stop applying a mobility robustness action using same techniques (e.g. in a RRC, MAC or physical layer message or signal, proximity indication message, other messages, and the like). Alternatively, the UE may report to the network that a trigger to initiate one of the mobility robustness actions described above may be met such that the UE may start (e.g. autonomously) the mobility robustness action or may wait for an indication from the network.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for providing mobility robustness in a heterogeneous network, the method comprising:
receiving information from a network;
determining whether a robustness situation is configured to occur based on the received information;
initiating a mobility robustness action when, based on the determination, the robustness situation is configured to occur.

2. The method of claim 1, wherein the information comprises at least one of the following: a physical cell identity (PCI), configuration information, measurement information, and network information.

3. The method of claim 1, wherein the mobility robustness action comprises a target cell pre-configuration procedure.

4. The method of claim 3, wherein the target cell pre-configuration procedure comprises pre-configuring user equipment (UE) with target cell information or parameters.

5. The method of claim 4, wherein the target cell pre-configuration procedure further comprises:
preparing a target cell for a handover configured to occur at a subsequent time; and
performing the handover using the pre-configured target cell information or parameters.

6. The method of claim 1, further comprising performing a fast reestablishment procedure using the pre-configured target cell information or parameters.

7. The method of claim 1, wherein the mobility robustness action comprises at least one of the following: an active time extension in discontinuous reception (DRX), application of an almost blank subframe (ABS), modification of a measurement configuration, or modification of a mobility state.

8. A method for providing mobility robustness in a heterogeneous network, the method comprising:
detecting an occurrence of an event or trigger;
determining whether to initiate a mobility robustness action based on the occurrence of the event or trigger; and
performing the mobility robustness action if, based on the determination, the mobility robustness action is configured to be initiated based on the occurrence of the event or trigger.

9. The method of claim 8, wherein the event or trigger comprises at least one of the following: a proximity mobility trigger or event or a measurement trigger or event.

10. The method of claim 9, wherein the measurement trigger or event comprises at least one of the following: a neighbor cell channel quality being greater than a threshold, a source cell quality being less than a threshold, a change of best cell, or a measurement report being triggered.

11. The method of claim 8, wherein the mobility robustness action comprises a target cell pre-configuration. procedure.

12. The method of claim 11, wherein the target cell pre-configuration procedure comprises pre-configuring user equipment (UE) with target cell information or parameters.

13. The method of claim 12, wherein the target cell pre-configuration procedure further comprises:
preparing a target cell for a handover configured to occur at a subsequent time; and
performing the handover using the pre-configured target cell information or parameters.

14. The method of claim 12, further comprising performing a fast reestablishment procedure using the pre-configured target information or parameters.

15. The method of claim 8, wherein the mobility robustness action comprises at least one of the following: an active time extension in discontinuous reception (DRX), application of an almost blank subframe (ABS), modification of a measurement configuration, or modification of a mobility state.

16. A method for providing mobility robustness in a heterogeneous network, the method comprising:
receiving information associated with cells;
determining whether the information associated with the cells provides an indication to apply a mobility robustness action; and
applying the mobility robustness action, if based on the determination, the information associated with the cells indicates provides the indication to apply the mobility robustness action.

17. The method of claim 16, wherein the information associated with the cells comprises a physical cell identity (PCI).

18. The method of claim 17, wherein determining whether the information associated with the cells provides the indication to apply the mobility robustness action comprises determining whether a cell is a mobility robust cell based on the PCI.

19. The method of claim 16, wherein the mobility robustness action comprises at least one of the following: a target cell pre-configuration procedure, a pre-handover preparation, an active time extension in discontinuous reception (DRX), application of an almost blank subframe (ABS), modification of a measurement configuration, or modification of a mobility state.

20. The method of claim 16, further comprising performing a handover in response to the mobility robustness action.
